(19) United States
(12) Patent Application Publication
(10) Pub. No.: US 2013/0331971 A1
(43) Pub. Date: Dec. 12, 2013

(54) WATERMARKING AND USING SAME FOR AUDIENCE MEASUREMENT

(71) Applicants: Eran BIDA, Ramat Gan (IL); Eran Yarom, Even Yehuda (IL); Raymond Eskenazi, Raanana (IL)

(72) Inventors: Eran BIDA, Ramat Gan (IL); Eran Yarom, Even Yehuda (IL); Raymond Eskenazi, Raanana (IL)

(21) Appl. No.: 13/492,871

(22) Filed: Jun. 10, 2012

(51) Int. Cl. G06F 17/00

(52) U.S. Cl. 700/94

(57) ABSTRACT

A method for watermarking an audio signal may include embedding in the audio signal a watermark that includes a plurality of mute intervals of a predetermined characteristics. A method for audience measuring may include, for each media content item of a multi-content media broadcast, embedding a unique watermark that includes a plurality of mute intervals of a predetermined characteristics in an audio signal of that media content item. The method may further include, at a media player that plays a media content item from multi-content media broadcast, acquiring the audio signal of the media content item being played. The method may further include detecting the embedded watermark in that audio signal and comparing the detected embedded watermark with the unique watermark of each of the media content items of the multi-content media broadcast to determine which media content item of the multi-content media broadcast was played by the media player.

### BACKGROUND

The abundance of media content nowadays has brought about the need to measure actual exposure of target audiences to media content. Knowing the actual media content which is being consumed by a single user or by a group of users is valued.

For example, commercial firms and businesses are interested in knowing the scope of exposure of the public to their advertised goods and services. Advertisers are interested in knowing the extent of which their advertisements are actually listened to or viewed (hereinafter will be referred to as “viewed” for brevity) by potential customers to attest their skill and quality of their services to potential customers. Media content provided (such as television, cable, satellite and radio broadcasting channels) are also interested in learning the extent of which advertisements are actually viewed in order to be able to assess the actual value of their advertising channels and be able to properly charge for their services.

Media channels may be television channels, IP television channels, radio channels, internet channels and the like.

In the past audience measurements were made by members of an audience which were asked to manually record their viewing habits.

More technology oriented audience measurement system were introduced, in which a set-top box (STB) connected to a TV set identified and recorded the channel that was currently viewed and that information was forwarded to a remote tracking station (e.g. over a telephone line).

Watermarking is known to have been used in identifying media content. Watermarking involves embedding information into a digital signal in the form of a digital signature. For example, a photograph may include a visible watermark that manifests copyright ownership. TV stations typically embed the station's logo at a corner of the video screen to allow viewer to easily identify the station when zapping. Hidden watermarks may also be used, for example by embedding a digital signature in a digital TV channel which requires some form of processing to retrieve the digital signature and identify it.

### SUMMARY OF THE INVENTION

There is thus provided, according to embodiments of the present invention, a method for watermarking an audio signal. The method may include embedding in the audio signal a watermark that includes a plurality of mute intervals of a predetermined characteristics.

According to embodiments of the present invention, the predetermined characteristics may include a predetermined pattern.

According to embodiments of the present invention, the plurality of mute intervals may include mute intervals of a duration of up to 40 milliseconds.

According to embodiments of the present invention, the plurality of mute intervals may be distributed periodically in the watermark.

According to embodiments of the present invention, embedding the watermark in the audio signal may include embedding the watermark in a plurality of predetermined locations in the audio signal.

According to embodiments of the present invention, the predetermined locations may include a beginning portion or an end portion of the audio signal.

According to embodiments of the present invention, the method may further include acquiring the audio signal with the embedded watermark by a receiver. The method may also include detecting the embedded watermark, and comparing the detected embedded watermark with a list of unique reference watermarks associated with different media content items to determine whether the detected watermark matches one of the reference watermarks.

According to embodiments of the present invention, the detecting of the embedded watermark may include dividing the audio signal into consecutive segments. The method may also include determining an energy level for each of the segments. The method may further include identifying groups of adjacent segments of the consecutive segments in which the energy level of each of the segments of any of the groups is below a predetermined threshold indicative of existence of one of the mute intervals. The method may also include determining, based on the location of the identified groups in the audio signal, the existence of the embedded watermark in the audio signal.

According to embodiments of the present invention, there is also provided a method for audience measuring. The method may include, for each media content item of a multi-content media broadcast, embedding a unique watermark that includes a plurality of mute intervals of a predetermined characteristics in an audio signal of that media content item. The method may also include, at a media player that plays a media content item from multi-content media broadcast, acquiring the audio signal of the media content item being played. The method may further include detecting the embedded watermark in that audio signal and comparing the detected embedded watermark with the unique watermark of each of the media content items of the multi-content media broadcast to determine which media content item of the multi-content media broadcast was played by the media player.

According to embodiments of the present invention, the media content item comprises a channel and wherein the multi-content media broadcast may include a multi-channel broadcast.

According to embodiments of the present invention, the media content item may be an advertisement.

According to embodiments of the present invention, the method may further include transmitting location data from a location device associated with the media player to a remote server to determine the location of the media player.

According to embodiments of the present invention, the location data may include Global Positioning System (GPS) location data and wherein the location device may include a GPS device.

According to embodiments of the present invention, there is provided an audience measuring system. The system may include a receiver to acquire an audio signal of a media content item of a multi-content media broadcast which is played by a media player, wherein each media content item of the multi-content media broadcast includes an embedded unique watermark that includes a plurality of mute intervals of a predetermined characteristics in an audio signal of that media content item. The system may also include a processor to detect the embedded watermark in that audio signal and to compare the detected embedded watermark with the unique watermark of each of the media content items of the multi-content media broadcast to determine which of the media content items of the multi-content media broadcast was played on the media player.

According to embodiments of the present invention, the system may also include a communication module to communicate data relating to the embedded watermark to a remote server.

According to embodiments of the present invention, the communication module may be configured to communicate location data relating to the location of the media player to the remote server.

According to embodiments of the present invention, the location data may include GPS location data.

According to embodiments of the present invention, the system may further include a location device for determining the location of the media player.

According to embodiments of the present invention, the location device may include a GPS device.

### BRIEF DESCRIPTION OF THE DRAWINGS

Embodiments of the present invention are described in the following detailed description and illustrated in the accompanying drawings in which:

FIG. 1 illustrates an audio signal with an embedded watermark, according to embodiments of the present invention;

FIG. 2 illustrates a method for audience measuring in accordance with embodiments of the present invention

FIG. 3 illustrates a system for media content distribution with audience measuring, in accordance with some embodiments of the present invention;

FIG. 4 illustrates an audience measuring device according to some embodiments of the present invention;

FIG. 5 illustrates an algorithm for detecting a watermark embedded in an audio signal that includes a plurality of mute intervals and identifying the media content item associated with that watermark, in accordance with some embodiments of the present invention.

### DETAILED DESCRIPTION

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments of the present invention described herein are not constrained to a particular order or sequence. Additionally, some of the described method embodiments of the present invention or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

While embodiments of the present invention may be directed towards various kinds of media content and users, embodiments described in detail hereinafter refer to TV media content, TV sets and to viewers for brevity. However the scope of the invention is not limited to TV media content and to viewers only, and may encompass other audio media content, video media content (with associated audio signal), and other media players (e.g. radio sets, computers, hand-held devices such as ipads, tablets, etc) that play audio or video with audio.

“Media content” in the context of the present invention may refer to any audio or video media content. By “media content item” is meant, in the context of the present invention, any media content item (audio or video) which includes an audio signal and which has a defined characteristic (e.g. source, duration, content, etc.). Such media content item may include, for example a broadcast channel, a broadcast program (e.g. a movie, a reportage etc.), an advertisement, etc.

“Video media content” in the context of the present invention may refer to video media content which includes audio as well.

“Viewers” in the context of the present invention may refer to viewers viewing video media content or to listeners listening to audio media content.

According to some embodiments of the present invention it is suggested to embed a watermark (hereinafter—“the watermark”) in an audio signal, which may be either a stand-alone audio signal of audio media content, or an audio signal which is associated with video media content, that includes a sequence of one or more mute intervals.

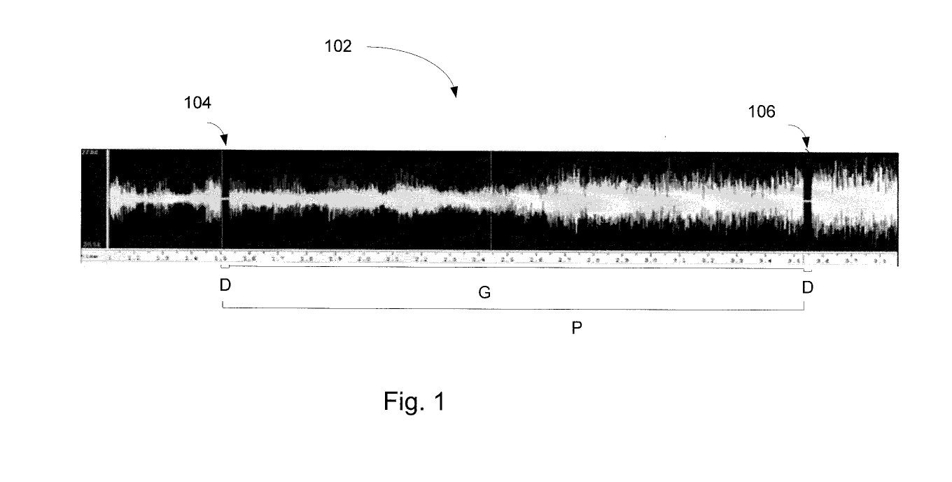

FIG. 1 illustrates an audio signal with an embedded watermark, according to embodiments of the present invention.

Audio signal 102 includes a watermark that includes a plurality of mute intervals (shown are two mute intervals 104, 106. Each mute interval (104, 106) has a predetermined duration D, and the mute intervals are separated by a gap G. The period P of the watermark mute intervals is P (equals to D+G).

Parameters of the sequence of mute intervals, such as for example, the number of mute intervals, the duration of the mute intervals (D), the duration of gaps (G) between the intervals (and consequently the period P) may vary.

According to embodiments of the present invention a plurality of copies of the watermark may be embedded in the audio signal. Copies of the watermark may be embedded sequentially, separated by time gaps. The time gaps may be equal time gaps.

In some embodiments of the present invention the watermark may be embedded at predetermined locations in the audio signal. In some examples the watermark may be embedded at the beginning of the audio signal or at the end of the audio signal.

While the duration of the mute intervals may vary, it is asserted it would be sensible to limit the acceptable duration of the mute intervals to a threshold above which the mute intervals become noticeable or annoyingly noticeable to the human ear. In some embodiments of the present invention the mute intervals of the watermark may be limited to no more than 40 milliseconds.

In some embodiments of the present invention the mute intervals of the watermark may be limited to no less than a few milliseconds (e.g. in some embodiments no less than 5 milliseconds, in some other embodiments no less than 7 milliseconds, in yet other embodiments no less than 10 milliseconds).

According to embodiments of the present invention different media content items would be marked by different watermarks. Thus, for example, a watermark embedded in the audio signal of a first media content item may include a sequence of mute intervals of 25 milliseconds each, separated by gaps of 1800 milliseconds, a watermark embedded in the audio signal of a second media content item may include a sequence of mute intervals of 25 milliseconds each, separated by gaps of 2300 milliseconds, and a watermark embedded in a third media content item may include a sequence of mute intervals of 25 milliseconds each, separated by gaps of 2700 milliseconds.

In other embodiments of the present invention, for example, the number of the mute intervals in each watermark may be different so as to distinguish between media content items in which the watermarks are embedded.

In yet other embodiments of the present invention, for example, the period P of each watermark may vary in a unique manner so as to distinguish between watermarks relating to different media content items. For example, the gaps between mute intervals, in one watermark may vary linearly (e.g. the gap between the first and second mute intervals may be 1500 milliseconds, the gap between the second and third mute intervals 1800 milliseconds, the gap between the third and the fourth mute intervals 2100 milliseconds and so on).

While many variations in the parameters of the watermark may be considered it seems very practical and simple to distinguish between watermarks by assigning each watermark with different gaps G, while the duration D of the mute intervals is kept constant and relatively close to the threshold above which the mute intervals become noticeable or annoyingly noticeable to the human ear. Keeping the duration D of the mute intervals constant and relatively close to that threshold allows simple and convenient detection of the watermark as is explained hereinafter.

A list of reference watermarks could be made which identifies various media content items by their embedded watermark so that it would be possible to determine what media content item was viewed by identifying the watermark embedded in the audio signal of that media content item and referring to the list of reference watermarks.

In order to identify the media content item viewed by an end user the audio signal of the media content item being actually played by a player device of the end user, the audio signal of that media content item would be apprehended and analyzed to detect the watermark. The detected watermark would then be compared with the watermark reference list and if a match if found between the detected watermark and a watermark from the reference list it would be possible to identify the played media content item as the media content item associated with the matching watermark from the reference list.

The watermark may be embedded periodically in the audio signal. For example, the watermark may be embedded in the audio signal every one or a few seconds.

In another example, the watermark may include a plurality of mute intervals of predetermined duration D that are embedded along the entire length of the audio signal, or a substantial portion thereof, and which are separated by a predetermined gap G.

A method for watermarking a media content item that includes an audio signal, according to embodiments of the present invention may include embedding a watermark in the audio signal that includes a sequence of mute intervals of a predetermined characteristics. The embedded sequence of mute intervals may be provided in a predetermined pattern.

Watermarking in accordance with embodiments of the present invention may be used for audience measurements, where it is desired to determine whether a specific media content item of a plurality of media content items was actually viewed by one or a plurality of audience members.

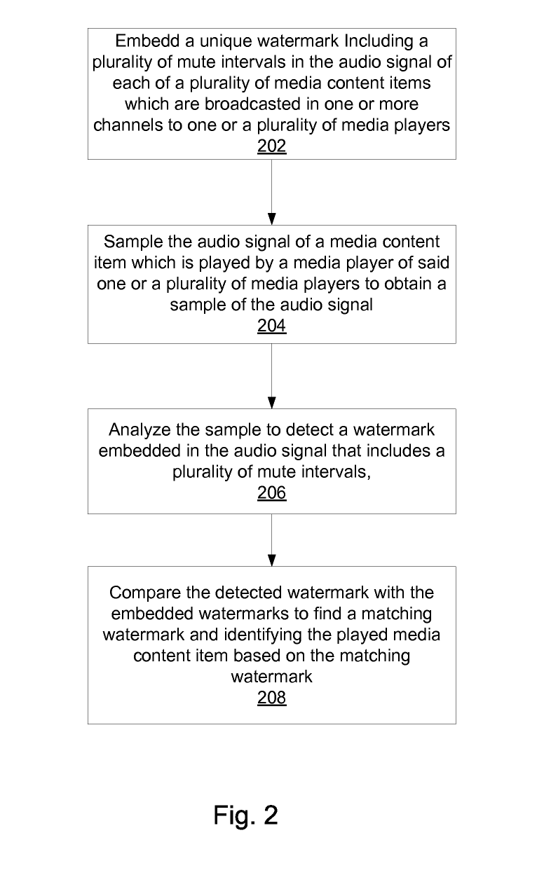

FIG. 2 illustrates a method for audience measuring in accordance with embodiments of the present invention. Method 200 may include embedding 202 a unique watermark comprising a plurality of mute intervals in the audio signal of each of a plurality of media content items which are broadcasted in one or more channels to one or a plurality of media players. The method may also include sampling 204 the audio signal of a media content item which is played by a media player of said one or a plurality of media players to obtain a sample of the audio signal. The method may further include analyzing 206 the sample to detect a watermark embedded in the audio signal that includes a plurality of mute intervals, and comparing 208 the detected watermark with the embedded watermarks to find a matching watermark and identifying the played media content item based on the matching watermark.

According to embodiments of the present invention, in order to detect and identify the watermark embedded in the audio signal, a sample of the signal which includes the entire audio signal or a portion of it (the duration of which is set to a minimal length to ensure that the embedded watermark would be included) is apprehended and analyzed.

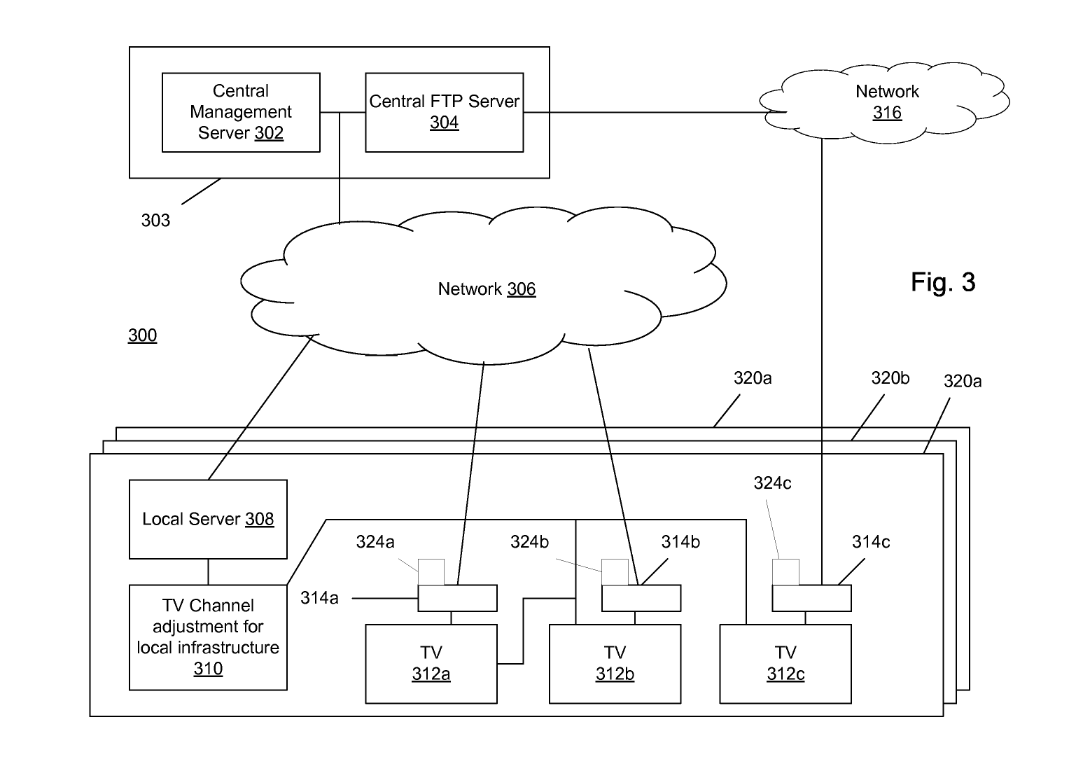

FIG. 3 illustrates a system 300 for media content distribution with viewing measuring, in accordance with some embodiments of the present invention.

A central management facility 303 may include a central management server 302 and a central FTP server 304.

Central management server 302 may be configured to manage local broadcasting environments 320a, 320b and 320c. A local broadcasting environment may include, for example, a hotel or a chain of hotels, a university campus, hospital, a local neighborhood or any other group of viewers.

Central Management Server 302 manages media content distribution to local broadcasting environments, 320a, 320b and 320c. Media content is copied to the local server 308 of each of the local broadcasting environments 320a, 320b and 320c. The Central Management Server 302 also provides administration capabilities over the entire system and network. This may include presenting local servers status, managing media content items (e.g. media files) on the local server 308 (e.g. copying video files of new movies, advertisements video clips, music clips etc.) and managing the playlist on the local server to determine the content that will be played on each channel that the local server generates at a given time.

The central management server 302 may communicate with the local server 308 at each local broadcasting environment 320a, 320b and 320c. The communication may be conducted over network 306 (e.g. the Internet). For example, local server 308 may open a VPN connection to central management server 302 (which may also operate as a VPN server). VPN connection is considered secured and is encrypted.

According to some embodiments of the present invention, central management server 302 may provide an access interface allowing access to authorized users, e.g. administrator and content managers.

According to embodiments of the present invention a content manager may be allowed to perform some or all of the following actions:

1) View status of local servers that they were granted permissions to view or access (administrator user can create content manager users and grant them permission to local servers); perform manual synchronization of the local server 308 in which a playlist and media files associated with the playlist (in case that the local server 308 does not have them) are copied to the local server. In some embodiments of the present invention the local server 308 includes a storage device in which the playlist and media files are stored. The storage device may include an encrypted file system;

2) Upload/remove video files movies or advertisements;

3) Manage system entities, such as:

a) Movie structure—the movie structure entity may include a list of video files, each broadcasted on a separate channel. Movie structure may include metadata related to the movie and also tags between the video files of the movies that may be used for automatic embedding of commercials by a playlist creation algorithm;

b) Playlist—a playlist may be created by the central management server 302 for local server 308 or for a group of local servers of different local broadcasting environments (e.g. 320a, 320b and 320c). A playlist may be generated for each of the channels of the local server. The playlist may be issued daily, weekly, or on any other time period basis. The web interface may allow the administrator or the content managers to edit the playlist, to copy a playlist between time periods and between local servers playlists;

c) Information channel layout and content—information channel may be one of channels that the local server 308 generates. The information channel may present a program guide for available channels of the local server 308, advertisements and other information.

Local server 308 may receive video files of video and advertisements from the central management server 302. In addition local server 308 may receive from the central management server 302 a playlist file (e.g. a XML file) that defines the playlist for a predefined period of time ahead (e.g. the next couple of weeks). The playlist file may be generated by the central management server 302 either by a manual command (by an administrator of the system or by a content manager) or automatically (e.g. every hour) and may be copied to the local server 308. There may be a different playlist for each local server of the local broadcasting environments (320a, 320b and 320c). The playlist may include information on video media content to be aired for one or more channels.

Local server 308 may output TV channels. For examples, local server 308 may support analog TV broadcasting or digital TV broadcasting. TV channel adjustment for local infrastructure 310 may be used.

For example, in analog TV broadcasting, video and audio of each channel are forwarded to a modulator. The modulator sets a frequency for each analog TV channel. An RF cable outputs the channel. A network of amplifiers and aggregators may be employed that combines this channel with other channels that originate either from the local server 308 (other channels from the local server), or channels from other sources (e.g. cable, satellite channels). Amplifiers may be used to enhance the TV signal if needed and aggregators may be used to combine a few channels together. Eventually a single RF cable connects to the TV sets 312a, 312b and 312c of the local broadcasting environment. In digital TV broadcasting, TV channel adjustment for local infrastructure 310 may include digital broadcast modulator cards such as, for example, DecTek's DTA-110T or DTA-111 cards. Such a card typically has a single output that outputs from the local server 308 a transport stream that multiplexes a plurality of channels originating from the local server 308. The plurality of channels are integrated to a digital TV broadcast system that sends the digital TV channels to the TV sets 312a, 312b and 312c.

According to some embodiments of the present invention the local server 308 is configured to embed a unique watermark that includes a plurality of mute intervals in the audio signal of each of the media content items which are broadcasted from the local server in one or more channels to one or a plurality of media players of the local broadcasting environment.

According to other embodiments of the present invention the central management server 302 is configured to embed a unique watermark that includes a plurality of mute intervals in the audio signal of each of the media content items which are distributed to local servers.

An audience measuring device 314a, 314b and 314c is provided for each TV set 312a, 312b ad 312c respectively. The audience measuring device is configured to receive the audio signal of the media content being played by the TV set and detect the watermark. Each audience measuring device (314a, 314b and 314c) may include a locator device (e.g. a GPS device 324a, 324b and 324c respectively).

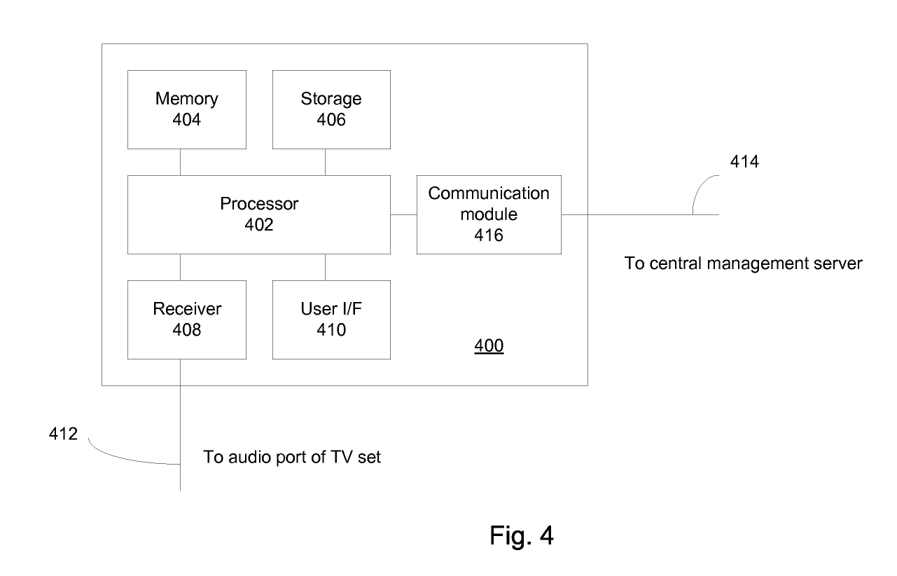

FIG. 4 illustrates an audience measuring device 400 according to some embodiments of the present invention.

The audience measuring device 400 may include a receiver 408 for receiving the audio signal of a media content item played on the TV set. For example, receiver 408 may be connected to the TV set by a connecting wire having a plug that is plugged into an “audio out” socket of the TV set. In an alternative embodiment a microphone may be placed adjacent to the loudspeaker of the TV set. Noise filtering may be involved. In case of an analog audio out socket an analog to digital (A/D) converter may also be used to convert the analog audio signal into a digital signal. Processor 402 receives the audio signal and analyzes it to detect a watermark that includes a sequence of mute intervals, and compares it with a list of reference watermarks which may be stored on non-transitory storage medium 406 (e.g. hard disk, flash memory, etc.), with which the detected watermark is compared. If a match is found between the detected watermark and one of the reference watermarks the media content item that was played on the TV set is identified as a media content item that was associated with that reference watermark. Storage medium 406 may be used to store program instructions for a method for identifying media content items in accordance with embodiments of the present invention, as well as data. Memory 404 may be used by processor 402 when operating. Events of detection of watermarks and identification o reference watermarks may be logged. Location data may also be logged (e.g. location data of the audience measurement device which reports in, such as GPS location data).

Communication module 416 may be used to communicate with the central management facility, see 303 in FIG. 3 (e.g. with the FTP server). Such communication may include sending logged events to the FTP server.

According to some embodiments of the present invention an algorithm for detecting the watermark may include dividing the audio signal into consecutive segments and determining an energy level for each of the segments. Then groups of the consecutive segments may be identified in which the energy level of each of the segments of any of the group is below a predetermined threshold indicative of existence of one of the mute intervals. Based on knowing the unique characteristics of each watermark it is then possible to determine the existence of one of the reference watermarks in the audio signal.

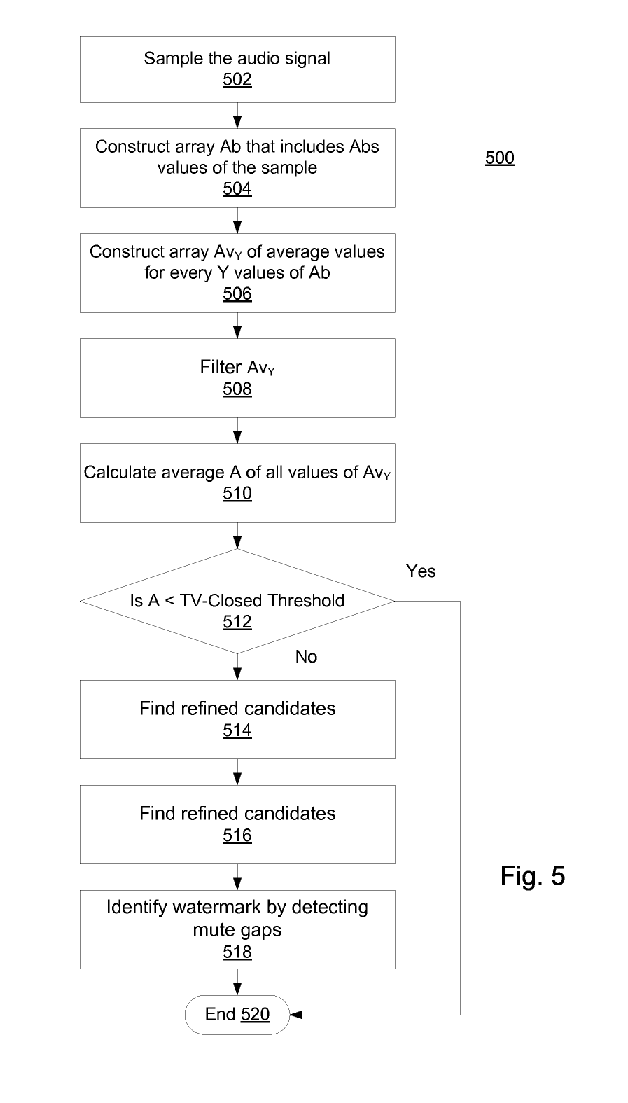

FIG. 5 illustrates an algorithm 500 for detecting a watermark embedded in an audio signal that includes a plurality of mute intervals and identifying the media content item associated with that watermark, in accordance with some embodiments of the present invention.

Algorithm 500 may include sampling 502 the audio signal (e.g. obtaining a sample of a predetermined duration (e.g. 30 seconds). The sample would typically contain an array of audio values.

Next, an array Ab of the absolute values of the audio values of the sample is constructed 504 and an array Av_{Y} of average values of averaging every Y consecutive absolute values of array Ab is constructed 506. Y may be given by:

$$Y = \frac{( {R}_{S} / 1000 ) * Z}{4} ,$$

where R_{S} is the sampling rate, Z is the duration of the mute gaps of the anticipated watermark (e.g., Z=30 ms and R_{S}=8,000 Hz).

Then array Av_{Y} may be filtered 508 to remove consecutive values which are below a predetermined threshold and ignore them in the rest of the algorithm. The logic behind this is that if there is a sequence of consecutive audio samples with low absolute value then it would be difficult to find mute gaps inside this relatively silence period in the sample.

Then, an average value A of all elements of the filtered array Av_{Y} is calculated 510. A threshold (e.g. TV-CLOSED threshold) may be predetermined (that may be, for example, determined based on the TV model). It is determined 512 whether average value A is below or over that threshold. If A is below the threshold it may be determined that the TV set is closed (i.e., inactive) and the algorithm ends 520.

For A which is greater than threshold TV-CLOSED the algorithm seeks to detect and identify the watermark.

According to embodiments of the present invention a unique audio watermark is embedded in each channel of a plurality of broadcasted channels. According to an embodiment the audio watermarks may include, each, a sequence of mute intervals. For example, the audio watermarks may include identical mute intervals (e.g. of same length), and differ from one another in the gaps between these mute intervals. For example, the mute gaps may be of Z milliseconds (e.g. 30 ms) that occur every B seconds (e.g. B can be for example 1.8 second for one channel, 2 seconds for another channel and 2.2 seconds for a third channel). Thus, for each channel the algorithm continues by finding 514 raw candidates. According to an embodiment of the present invention, a Boolean array (e.g. called RealCandidates) having the same size as Av_{Y} array may be considered. Its purpose is to mark a group of S of the smallest values in Av_{Y} array. If element i of Av_{Y} is included among this group of S smallest values of Av_{Y}, then element i in RealCandidates array may be marked true, otherwise it is marked false. The elements of Av_{Y} that were filtered out may also be marked as false.

Then, the algorithm continues by fining 516 refined candidates. For example, another Boolean array called RefinedCandidates may be considered having the same size as RealCandidates array may be considered. Let C be the number of consecutive array elements in RefinedCandidates which correspond to 30 milliseconds sample. For each element i of RefinedCandidates array, set its value to true if and only if C consecutive elements are all true (e.g. iff element i and all of the next consecutive C−1 elements RawCandidates[i]==true and RawCandidates[i+1]==true . . . and RawCandidates[i+C−1]==true).

Then the gaps between the mute intervals are checked. B represents the gap between mute intervals which exists in a known audio watermark. B corresponds to G elements in RefinedCandidates array (i.e. G consecutive elements in the array reflecting sample time of B). For each element i in RefinedCandidates which has a true value, go over all elements in RefinedCandidates array in index j, where j=i+G*c+T (where c grows from 0 in increments of 1 while j is smaller than the size of RefinedCandidates array, and T is a threshold with values for example from −3 up to 3—that allow search in the surrounding of candidates), and count how many of these elements have value true—this value may be marked as V.

If V is close enough to the maximum number of mute intervals that can appear in the input audio sample then detection of the known audio watermark (and consequently the channel which is linked with that audio watermark) may be positively identified 518, ending 520 the algorithm.

Embodiments of the present invention may be embodied in the form of a system, a method or a computer program product. Similarly, embodiments of the present invention may be embodied as hardware, software or a combination of both. Embodiments of the present invention may be embodied as a computer program product saved on one or more non-transitory computer readable medium (or mediums) in the form of computer readable program code embodied thereon. Such non-transitory computer readable medium may include instructions that when executed cause a processor to execute method steps in accordance with embodiments of the present invention. In some embodiments of the present invention the instructions stores on the computer readable medium may be in the form of an installed application and in the form of an installation package.

Such instructions may be for example loaded into one or more processors and executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer, or on a plurality of computers.

Embodiments of the present invention are described hereinabove with reference to flowcharts and/or block diagrams depicting methods, systems and computer program products according to embodiments of the present invention.

What is claimed is:

1. A method for watermarking an audio signal, the method comprising:
embedding in the audio signal a watermark that includes a plurality of mute intervals of a predetermined characteristics.

2. The method of claim 1, wherein the predetermined characteristics comprises a predetermined pattern.

3. The method of claim 1, wherein the plurality of mute intervals comprises mute intervals of a duration of up to 40 milliseconds.

4. The method of claim 1, wherein the plurality of mute intervals are distributed periodically in the watermark.

5. The method of claim 1, wherein embedding the watermark in the audio signal comprises embedding the watermark in a plurality of predetermined locations in the audio signal.

6. The method of claim 5, wherein the predetermined locations include a beginning portion or an end portion of the audio signal.

7. The method of claim 1 further comprising:
acquiring the audio signal with the embedded watermark by a receiver;
detecting the embedded watermark; and
comparing the detected embedded watermark with a list of unique reference watermarks associated with different media content items to determine whether the detected watermark matches one of the reference watermarks.

8. The method of claim 7, wherein the detecting of the embedded watermark comprises dividing the audio signal into consecutive segments;
determining an energy level for each of the segments;
identifying groups of adjacent segments of the consecutive segments in which the energy level of each of the segments of any of the groups is below a predetermined threshold indicative of existence of one of the mute intervals;
determining, based on the location of the identified groups in the audio signal, the existence of the embedded watermark in the audio signal.

9. A method for audience measuring comprising:
for each media content item of a multi-content media broadcast, embedding a unique watermark that includes a plurality of mute intervals of a predetermined characteristics in an audio signal of that media content item;
at a media player that plays a media content item from multi-content media broadcast, acquiring the audio signal of the media content item being played;
detecting the embedded watermark in that audio signal; and
comparing the detected embedded watermark with the unique watermark of each of the media content items of the multi-content media broadcast to determine which media content item of the multi-content media broadcast was played by the media player.

10. The method of claim 9, wherein the media content item comprises a channel and wherein the multi-content media broadcast comprises a multi-channel broadcast.

11. The method of claim 9, wherein the media content item is an advertisement.

12. The method of claim 9, further comprising transmitting location data from a location device associated with the media player to a remote server to determine the location of the media player.

13. The method of claim 12, wherein the location data comprises Global Positioning System (GPS) location data and wherein the location device comprises a GPS device.

14. An audience measuring system comprising:
a receiver to acquire an audio signal of a media content item of a multi-content media broadcast which is played by a media player, wherein each media content item of the multi-content media broadcast includes an embedded unique watermark that includes a plurality of mute intervals of a predetermined characteristics in an audio signal of that media content item;
a processor to detect the embedded watermark in that audio signal and to compare the detected embedded watermark with the unique watermark of each of the media content items of the multi-content media broadcast to determine which of the
media content items of the multi-content media broadcast was played on the media player.

15. The system of claim 14, further comprising a communication module to communicate data relating to the embedded watermark to a remote server.

16. The system of claim 15, wherein the communication module is configured to communicate location data relating to the location of the media player to the remote server.

17. The system of claim 16, wherein the location data comprises GPS location data.

18. The system of claim 14, further comprising a location device for determining the location of the media player.

19. The system of claim 18, wherein the location device comprises a GPS device.
